(19) United States
(12) Patent Application Publication
(10) Pub. No.: US 2026/0120225 A1
(43) Pub. Date: Apr. 30, 2026

(54) GPU PERFORMANCE OPTIMIZATION

(71) Applicant: Dell Products L.P., Round Rock, TX (US)

(72) Inventors: Parminder Singh SETHI, Punjab (IN); Pandiyarajan MANI, Gudiyattam (IN); Vinoth Raja P, Thiruvarur (IN); Veena RAMARAO, Bangalore (IN)

(73) Assignee: Dell Products L.P., Round Rock, TX (US)

(21) Appl. No.: 18/926,534

(22) Filed: Oct. 25, 2024

(51) Int. Cl. G06T 1/20

(52) U.S. Cl. CPC G06T 1/20

(57) ABSTRACT

An information handling system may include at least one processor, a GPU, and a memory. The information handling system may be configured to: receive information regarding configuration settings and performance levels of GPUs of other information handling systems; determine a subset of the other GPUs associated with high performance levels; determine at least one configuration setting associated with the subset of the other GPUs; and adjust a corresponding configuration setting of the GPU based on the at least one configuration setting associated with the subset of the other GPUs.

### TECHNICAL FIELD

The present disclosure relates in general to information handling systems, and more particularly to optimization of accelerators such as graphics processing units (GPUs).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems may include one or more accelerators such as GPUs. For example, Peripheral Component Interconnect Express (PCIe) GPUs plug into standard PCIe slots. Other GPUs may use the Server PCI Express Module (SXM) form factor or the Open Compute Project (OCP) Accelerator Module (OAM) form factor, which offers bridge technology providing significantly higher interconnect bandwidth compared to PCIe. The SXM architecture is a high-bandwidth socketed solution for planar based GPUs.

In deployments with a large number of systems having complex hardware configurations, it can be difficult for the end user to ensure that each system operates at its maximum performance bandwidth under different workloads and with potentially different driver and firmware versions. This is particularly the case for SXM/OAM planar GPUs, which have an on-board bridge for GPU interconnect and PCIe switch boards for host interconnect. These two interconnects may play a large role in the GPU's bandwidth, in both bidirectional and unidirectional modes.

For example, suppose that a given deployment includes 5 servers with 8 GPUs each. Initially, these 40 GPUs may be configured optimally. But over time, the ecosystem may change due to new firmware upgrades, configuration changes, new servers being added, etc. Eventually there may be several changes in the system configuration compared to its initial setup, and the configuration of the GPUs may have room for significant improvement.

Embodiments of this disclosure implement a smart GPU performance optimization (SGPO) module for SXM/OAM based GPUs. The SGPO module may maintain maximum performance in SXM/OAM GPU platforms by adjusting settings (e.g., BIOS settings, GPU tuning settings, etc.), updating firmware, updating drivers, etc.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with achieving optimal performance in GPU-based systems may be reduced or eliminated.

In accordance with embodiments of the present disclosure, an information handling system may include at least one processor, a GPU, and a memory. The information handling system may be configured to: receive information regarding configuration settings and performance levels of GPUs of other information handling systems; determine a subset of the other GPUs associated with high performance levels; determine at least one configuration setting associated with the subset of the other GPUs; and adjust a corresponding configuration setting of the GPU based on the at least one configuration setting associated with the subset of the other GPUs.

In accordance with these and other embodiments of the present disclosure, a method may include an information handling system including a graphics processing unit (GPU) receiving information regarding configuration settings and performance levels of GPUs of other information handling systems; the information handling system determining a subset of the other GPUs associated with high performance levels; the information handling system determining at least one configuration setting associated with the subset of the other GPUs; and the information handling system adjusting a corresponding configuration setting of the GPU based on the at least one configuration setting associated with the subset of the other GPUs.

In accordance with these and other embodiments of the present disclosure, an article of manufacture may include a non-transitory, computer-readable medium having computer-executable instructions thereon that are executable by an information handling system for: receiving information regarding configuration settings and performance levels of graphics processing units (GPUs) of other information handling systems; determining a subset of the other GPUs associated with high performance levels; determining at least one configuration setting associated with the subset of the other GPUs; and adjusting a corresponding configuration setting of a GPU of the information handling system based on the at least one configuration setting associated with the subset of the other GPUs.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example workflow, in accordance with embodiments of the present disclosure.

### DETAILED DESCRIPTION

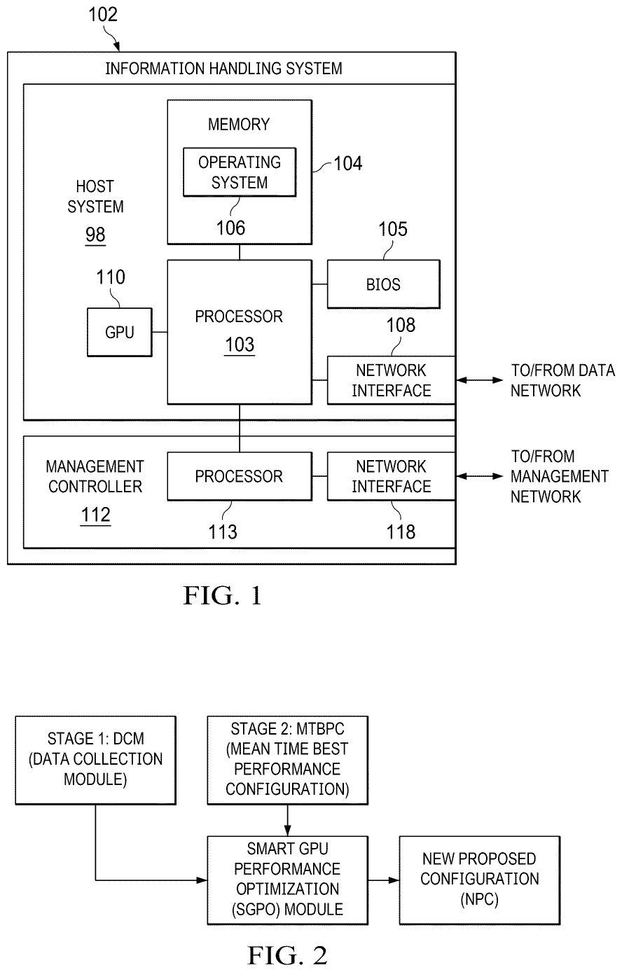

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

Information handling system 102 may also include one or more GPUs 110, which may be SXM/OAM planar GPUs. As discussed above, embodiments of this disclosure may be used to adjust various settings and configuration details to optimize the performance of GPUs 110.

FIG. 2 illustrates an example workflow, according to one embodiment. In Stage 1, a Data Collection Module (DCM) may run on a management controller such as a BMC of an information handling system in order to collect information about the current hardware and software configuration of the system. For example, the DCM may collect data regarding the CPU, memory, network card, GPUs, OS and patch level, BIOS configuration settings, OS configuration settings, GPU configuration settings, GPU workload, GPU usage for each slot, GPU temperatures, etc.

The DCM may collect the hardware and software configuration information using one or more different protocols. For example, the hardware information may be collected using a command such as “racadm gethwinventory”, which is implemented using Redfish protocols. The software information may be collected using a command such as “racadm getswinventory”, which may retrieve BIOS- and OS-level information from the host. Additionally, third-party tools such as a GPU analyzer may be used to fetch GPU performance and workload information from the GPU subsystem. All this information may be collected to aid in identifying performance issues with the current system configuration.

In some implementations, the DCM may also collect data from other datacenters or deployments as well. For example, each server's BMC may execute its own DCM to collect its information, and the DCM may then also connect to a remote server or cloud-based system (e.g., a manufacturer backend). This data may then be shared (e.g., in an anonymized fashion) to other datacenters, to increase the size of the pool of configuration data that may be relied upon to adjust the settings of any given GPU. The data associated with hardware configurations that are most similar to a given system may be given the most weight in the subsequent steps in some embodiments.

In Stage 2, a Mean Time Best Performance Configuration (MTBPC) module may analyze individual server performance data from Stage 1 for each server system for which data is available. For example, the DCM may collect hardware and software configuration data from other systems, and the MTBPC module may determine that certain configurations are associated with the highest performance levels (e.g., the highest bandwidth, the highest total throughput, the lowest training time for a particular machine learning model, or any other suitable measurement of performance). The MTBPC module may then calculate the average (the mean value) of each configuration setting that is associated with those best performance characteristics.

The SGPO module may receive the data from Stage 1 and Stage 2, comparing the results of both consolidated systems. The SGPO module may then create a New Proposed Configuration (NPC), which is designed to replicate the performance of the highest-performing GPUs from the dataset. The NPC may include a set of configuration settings that can be pushed to one or more of the systems in the datacenter to improve their GPU performance. Once the NPC has been implemented (e.g., by changing OS-level configuration settings, changing BIOS-level configuration settings, changing GPU tuning settings, updating drivers, updating firmware, and/or taking any other suitable steps), the SGPO may continue to monitor performance and look for further adjustments that may advantageously be made.

In some embodiments, the process described above may be enhanced by the inclusion of an artificial intelligence model. For example, an AI model may be configured to act continuously to maintain the maximum bandwidth in SXM/OAM GPU platforms by applying new configurations as necessary.

Accordingly, embodiments provide a method to determine the optimal GPU configuration settings for achieving improved performance by tapping into telemetry data and environment details. Embodiments also provide a method to detect and correct configurations as required for optimal performance. Embodiments also provide a method to alert the customer and sever management software as needed.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a graphics processing unit (GPU); and
a memory;
wherein the information handling system is configured to:
receive information regarding configuration settings and performance levels of GPUs of other information handling systems;
determine a subset of the other GPUs associated with high performance levels;
determine at least one configuration setting associated with the subset of the other GPUs; and
adjust a corresponding configuration setting of the GPU based on the at least one configuration setting associated with the subset of the other GPUs.

2. The information handling system of claim 1, wherein the GPU has a form factor of either Server PCI Express Module (SXM) or Open Compute Project (OCP) Accelerator Module (OAM).

3. The information handling system of claim 1, wherein adjusting the corresponding configuration setting of the GPU comprises:
determining an average of the at least one configuration setting across all GPUs in the subset; and
applying the determined average configuration setting to the GPU.

4. The information handling system of claim 3, wherein the average is a mean.

5. The information handling system of claim 1, wherein adjusting the corresponding configuration setting of the GPU comprises at least one of: adjusting an operating system configuration setting, adjusting a BIOS configuration setting, adjusting a GPU tuning setting, updating a driver, and updating a firmware.

6. The information handling system of claim 1, wherein a baseboard management controller of the information handling system is configured to adjust the corresponding configuration setting.

7. A method comprising:
an information handling system including a graphics processing unit (GPU) receiving information regarding configuration settings and performance levels of GPUs of other information handling systems;
the information handling system determining a subset of the other GPUs associated with high performance levels;
the information handling system determining at least one configuration setting associated with the subset of the other GPUs; and
the information handling system adjusting a corresponding configuration setting of the GPU based on the at least one configuration setting associated with the subset of the other GPUs.

8. The method of claim 7, wherein the GPU has a form factor of either Server PCI Express Module (SXM) or Open Compute Project (OCP) Accelerator Module (OAM).

9. The method of claim 7, wherein adjusting the corresponding configuration setting of the GPU comprises:
determining an average of the at least one configuration setting across all GPUs in the subset; and
applying the determined average configuration setting to the GPU.

10. The method of claim 9, wherein the average is a mean.

11. The method of claim 7, wherein adjusting the corresponding configuration setting of the GPU comprises at least one of: adjusting an operating system configuration setting, adjusting a BIOS configuration setting, adjusting a GPU tuning setting, updating a driver, and updating a firmware.

12. The method of claim 7, wherein a baseboard management controller of the information handling system is configured to adjust the corresponding configuration setting.

13. An article of manufacture comprising a non-transitory, computer-readable medium having computer-executable instructions thereon that are executable by an information handling system for:
receiving information regarding configuration settings and performance levels of graphics processing units (GPUs) of other information handling systems;
determining a subset of the other GPUs associated with high performance levels;
determining at least one configuration setting associated with the subset of the other GPUs; and
adjusting a corresponding configuration setting of a GPU of the information handling system based on the at least one configuration setting associated with the subset of the other GPUs.

14. The article of manufacture of claim 13, wherein the GPU has a form factor of either Server PCI Express Module (SXM) or Open Compute Project (OCP) Accelerator Module (OAM).

15. The article of manufacture of claim 13, wherein adjusting the corresponding configuration setting of the GPU comprises:
determining an average of the at least one configuration setting across all GPUs in the subset; and
applying the determined average configuration setting to the GPU.

16. The article of manufacture of claim 15, wherein the average is a mean.

17. The article of manufacture of claim 13, wherein adjusting the corresponding configuration setting of the GPU comprises at least one of: adjusting an operating system configuration setting, adjusting a BIOS configuration setting, adjusting a GPU tuning setting, updating a driver, and updating a firmware.

18. The article of manufacture of claim 13, wherein a baseboard management controller of the information handling system is configured to adjust the corresponding configuration setting.
